(19) United States
(12) Patent Application Publication
(10) Pub. No.: US 2015/0074106 A1
(43) Pub. Date: Mar. 12, 2015

(54) PROVIDING APPLICATION PROGRAM AND USER RECOMMENDATION INFORMATION

(71) Applicant: Alibaba Group Holding Limited, Grand Cayman (KY)

(72) Inventor: Jiangsheng Ji, Hangzhou (CN)

(21) Appl. No.: 14/483,009

(22) Filed: Sep. 10, 2014

(30) Foreign Application Priority Data
Sep. 11, 2013 (CN) 201310412738.4

(51) Int. Cl. G06F 17/30; H04L 29/08

(52) U.S. Cl. CPC G06F 17/30595; H04L 67/22
USPC 707/736

(57) ABSTRACT

The present disclosure provides example methods and devices of recommending application program and user recommendation information. Information of a use sequence of application programs used by a user at a terminal is determined. A correlation relationship of the application programs is determined according to the information of the use sequence. The correlation relationship of the application programs is uploaded to a server so that the server integrates the correlation relationship uploaded by each terminal to determine at least one third application program which is correlated with the first application program and sends recommendation information of correlated application program. Alternatively, at least one another user that is similar to the user is determined and recommendation information of similar user is provided. The present techniques improve an effectiveness of providing recommendation information.

### CROSS REFERENCE TO RELATED PATENT APPLICATIONS

This application claims foreign priority to Chinese Patent Application No. 201310412738.4 filed on 11 Sep. 2013, entitled “Method and Device of Providing Application Program and User Recommendation information,” which is hereby incorporated by reference in its entirety.

### TECHNICAL FIELD

The present disclosure is related to the technology of information recommendation and, more particularly, to a method and device for providing application program information and user recommendation information.

### BACKGROUND

With the popularity of smart portable terminals and the maturity of mobile Internet technology, there are more and more application programs that are exclusively designed for portable terminals and extend the functional advantages of the smart mobile terminals. General application programs for portable terminals may include types of services including a voice value-added service (such as a service related to voice messaging), a data application service (such as various instant messenger application programs, a mobile reader, a mobile game, etc.), an industrial application service (such as a mobile phone payment service, Internet of Things, a mobile banking service, an electronic identification service, and a mobile phone positioning service), etc.

However, due to an enormous number of the application programs, it may confuse users about which application should be chosen to install or use. For example, a user may not be able to choose a suitable application program from these enormous available application programs, or even have the suitable application program in a choosing list since the user is not familiar with this application program.

There are some conventional techniques that recommend application programs to the users. For example, a most installed or a most popular application program of a specific type may be recommended to the users. Alternatively, a latest available application program may be recommended to the users. However, as different users have different demands or use habits, very few recommended application programs by the conventional techniques are accepted by the users, thereby not only wasting related resources for recommending services but also affecting user experience.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides a method and device of providing application program and user recommendation information, which improves an effectiveness of recommendation and improves user experiences.

The present disclosure provides an example method of recommending related information of an application program. Information of a use sequence of application programs used by a user at a terminal is determined. A correlation relationship of the application programs is determined according to the information of the use sequence. The correlation relationship of the application programs is uploaded to a server so that the server integrates the correlation relationship uploaded by each terminal to determine at least one third application program which is correlated with the first application program and sends recommendation information of correlated application program.

The present disclosure also provides an example method of recommending similar user information. Information of a use sequence of application programs used by a user at a terminal is determined. A correlation relationship of the application programs is determined according to the information of the use sequence. The correlation relationship of the application programs is uploaded to a server so that the server integrates the correlation relationship uploaded by each terminal to determine at least one second terminal user that is similar to a first terminal user and sends recommendation information of similar terminal user.

The present disclosure also provides an example method of providing recommendation information of an application program. Information of a correlation relationship of the application programs sent by a terminal is received. The correlation relationship is determined by a terminal according to a use sequence of the application programs used by the user at the terminal. The correlation relationships sent by each terminal is integrated and a number of times that a third application program is correlated with the first application program is calculated. At least one third application program that is correlated with the first application program is determined. Recommendation information of the at least one third application program is provided to a terminal.

The present disclosure also provides an example method of providing recommendation information of similar use information. Information of a correlation relationship of the application programs sent by a terminal is received. The correlation relationship is determined by a terminal according to a use sequence of the application programs used by the user at the terminal. At least one second terminal user similar to a first terminal user is determined by comparing similarities of the correlation relationships sent by each terminal According to the at least one second terminal user that is determined as similar to the first terminal user, recommendation information of the second terminal user is provided to the first terminal user.

The present disclosure also provides another example method of providing recommendation information of an application program. Use information of application programs used by a user at a terminal is received from the terminal. Information of a use sequence of the application programs used by each user is determined according to the use information sent by each terminal. The use sequence information from each terminal is integrated and at least one third application program that is correlated with a first application program is determined. Recommendation information of the at least one third application program that is correlated with the first application program is provided to the terminal.

The present disclosure also provides an example method of providing user recommendation information. Use information of application programs used by a user at a terminal is received from the terminal. Information of use sequence of the application programs used by each user is determined according to the use information sent by each terminal. A similarity between a use sequence of one terminal user and another use sequence of another terminal user is determined. If the similarity between the use sequence of one terminal user and another use sequence of another terminal user satisfies a preset threshold, recommendation information of the second terminal user is provided to the first terminal user.

The present disclosure provides another example method of recommending related information of an application program. Use information of application programs used by a user at a terminal is received. The use information of the application programs is sent to a server so that the server determines information of a use sequence of application programs used by each terminal user according to the user information sent by each terminal. The server integrates the information of the use sequence of the application programs of each terminal, determines at least one third application program which is correlated with a first application program, and sends recommendation information of correlated application program.

The present disclosure also provides another example method of providing recommendation information of similar use information. Use information of application programs used by a user at a terminal is received. The use information of the application programs is sent to a server so that the server determines information of a use sequence of application programs used by each terminal user according to the user information sent by each terminal. The server integrates the information of the use sequence of the application programs of each terminal, determines at least one second terminal user that is similar to a first terminal user, and sends recommendation information of a similar terminal user.

The present disclosure provides an example device for recommending related information of an application program. The device may include a use sequence information determining unit, a correlation relationship determining unit, and an uploading unit. The use sequence information determining unit determines information of a use sequence of application programs used by a user at a terminal. The correlation relationship determining unit determines a correlation relationship of the application programs according to the information of the use sequence. The uploading unit uploads the correlation relationship of the application programs to a server so that the server integrates the correlation relationship uploaded by each terminal to determine at least one third application program which is correlated with the first application program and sends recommendation information of correlated application program.

The present disclosure also provides an example device for recommending similar user information. The device may include a use sequence information determining unit, a correlation relationship determining unit, and an uploading unit. The use sequence information determining unit determines information of a use sequence of application programs used by a user at a terminal. The correlation relationship determining unit determines a correlation relationship of the application programs according to the information of the use sequence. The uploading unit uploads the correlation relationship of the application programs to a server so that the server integrates the correlation relationship uploaded by each terminal to determine at least one second terminal user that is similar to a first terminal user and sends recommendation information of a similar terminal user.

The present disclosure also provides an example device for providing recommendation information of an application program. The device may include a correlation relationship receiving unit, a first calculating unit, and an application program recommendation providing unit. The correlation relationship receiving unit receives information of a correlation relationship of the application programs sent by a terminal. The correlation relationship is determined by the terminal according to a use sequence of the application programs used by the user at the terminal. The first calculating unit integrates the correlation relationships sent by each terminal, calculates a number of times that a third application program is correlated with the first application program, and determines at least one third application program that is correlated with the first application program. The application program recommendation providing unit provides recommendation information of the at least one third application program to a terminal.

The present disclosure also provides an example device for providing recommendation information of similar use information. The device may include a correlation relationship receiving unit, a second calculating unit, and a user recommendation providing unit. The correlation relationship receiving unit receives information of a correlation relationship of the application programs sent by a terminal. The correlation relationship is determined by the terminal according to a use sequence of the application programs used by the user at the terminal. The second calculating unit determines at least one second terminal user similar to a first terminal user by comparing similarities of the correlation relationships sent by each terminal. The user recommendation providing unit, according to the at least one second terminal user that is determined as similar to the first terminal user, provides recommendation information of the second terminal user to the first terminal user.

The present disclosure also provides another example device for providing recommendation information of an application program. The device may include a use information receiving unit, a use sequence determining unit, a correlation relationship determining unit, and an application program recommendation providing unit. The use information receiving unit receives use information of application programs used by a user at a terminal from the terminal. The use sequence determining unit determines information of use sequence of the application programs used by each user according to the use information sent by each terminal. The correlation relationship determining unit integrates the use sequence information from each terminal and determines at least one third application program that is correlated with a first application program. The application program recommendation providing unit provides recommendation information of the at least one third application program that is correlated with the first application program to the terminal.

The present disclosure also provides an example device for providing user recommendation information. The device may include a use information receiving unit, a use sequence determining unit, a user similarity determining unit, and a user recommendation providing unit. The use information receiving unit receives use information of application programs used by a user at a terminal from the terminal. The use sequence determining unit determines information of use sequence of the application programs used by each user according to the use information sent by each terminal. The user similarity determining unit determines a similarity between a use sequence of one terminal user and another use sequence of another terminal user. The user recommendation providing unit, when the similarity between the use sequence of one terminal user and another use sequence of another terminal user satisfies a preset threshold, provides recommendation information of the second terminal user to the first terminal user.

The present disclosure provides another example device for recommending related information of an application program. The device may include a use information obtaining unit and a use information sending unit. The use information obtaining unit obtains use information of application programs used by a user at a terminal. The use information sending unit sends the use information of the application programs to a server so that the server determines information of a use sequence of application programs used by each terminal user according to the user information sent by each terminal, integrates the information of the use sequence of the application programs of each terminal, determines at least one third application program which is correlated with a first application program, and sends recommendation information of correlated application program.

The present disclosure also provides another example device for providing recommendation information of similar user information. The device may include a use information obtaining unit and a use information sending unit. The use information obtaining unit obtains use information of application programs used by a user at a terminal. The use information sending unit sends the use information of the application programs to a server so that the server determines information of a use sequence of application programs used by each terminal user according to the user information sent by each terminal, integrates the information of the use sequence of the application programs of each terminal, determines at least one second user that is similar to a first terminal user, and sends recommendation information of a similar terminal user.

The present techniques utilize a use sequence of application programs when the user users the application program to determine application programs that probably have the correlation relationship, and further provide the user recommendation information related to the application programs, thereby improving an effectiveness of the recommendation information, an efficiency of recommending resources, and user experiences.

In addition, the present techniques, after collecting the use sequence of the application programs used by the user, not only recommend application programs that the user may be interested, but also provide recommend information of other users so that the user may find another that has similarity in using the application programs. Thus, the present techniques enable the user to conveniently find another user that has a similar using habit, avoid inconvenience to the user due to inaccurate recommendation to the user, thereby further improving the user experiences.

It is noted that a product implemented by the present techniques does not need to have all of the above merits at the same time.

### BRIEF DESCRIPTION OF THE DRAWINGS

The FIGs in the present disclosure are briefly described below to better illustrate the example embodiments of the present disclosure or the conventional techniques. The FIGs only describe some example embodiments of the present disclosure. One of ordinary skill in the art may obtain other figures based on the FIGs without using creative efforts.

FIG. 1 is a flowchart illustrating a first example method in accordance with the present disclosure.

FIG. 2 is a flowchart illustrating a second example method in accordance with the present disclosure.

FIG. 3 is a flowchart illustrating a third example method in accordance with the present disclosure.

FIG. 4 is a flowchart illustrating a fourth example method in accordance with the present disclosure.

FIG. 5 is a flowchart illustrating a fifth example method in accordance with the present disclosure.

FIG. 6 is a flowchart illustrating a sixth example method in accordance with the present disclosure.

FIG. 7 is a flowchart illustrating a seventh example method in accordance with the present disclosure.

FIG. 8 is a flowchart illustrating an eighth example method in accordance with the present disclosure.

FIG. 9 is a diagram illustrating a first example device in accordance with the present disclosure.

FIG. 10 is a diagram illustrating a second example device in accordance with the present disclosure.

FIG. 11 is a diagram illustrating a third example device in accordance with the present disclosure.

FIG. 12 is a diagram illustrating a fourth example device in accordance with the present disclosure.

FIG. 13 is a diagram illustrating a fifth example device in accordance with the present disclosure.

FIG. 14 is a diagram illustrating a sixth example device in accordance with the present disclosure.

FIG. 15 is a diagram illustrating a seventh example device in accordance with the present disclosure.

FIG. 16 is a diagram illustrating an eighth example device in accordance with the present disclosure.

### DETAILED DESCRIPTION

The following description describes the present disclosure with reference to the accompanied FIGs to clearly illustrate the technical solutions of the present disclosure. The described example embodiments are just a portion of embodiments instead of all embodiments of the present disclosure. Based on the example embodiments of the present disclosure, one of ordinary skill in the art may obtain other embodiments without using creative efforts, which are also under protection scope of the present disclosure.

During the process of implementing the present disclosure, certain correlation relationships of application programs used by a user are often found. For example, after reading a novel reading application program, the user often runs a music application program to play music or plays a game application program that he/she likes. Therefore the novel reading application program is correlated with the music application program or the novel reading application program to some extent. In other words, if the user often uses a second application program after using a first application program, then such sequential relationship may represent a behavior of the user. Furthermore, if a majority of users use the second application program after using the first application program, then this sequential relationship may further represent a potential correlation relationship in connection to these two application programs. Taking the novel reading application program as an example, most users tend to play an entertaining game after reading, thus the novel reading application programs and the entertaining game application programs may be considered as having a potential correlation relationship with each other. If recommendation information relating to application programs is provided to the user according to such potential correlation relationship, then an effectiveness of the recommendation information may be greatly improved. The present disclosure provides example methods of recommending application program based on the above considerations. Details are described below.

First of all, it should be noted that in an example detailed implementation, the present disclosure provides an application program for recommendation, which may include two portions, i.e., a client portion and a server portion. The client may be installed on a terminal device of each user, and the server portion may be installed on the server, both of which collaborate with each other to achieve the recommendation. The technical solution of the present disclosure is described from the perspectives of the client and the server in detail as follows.

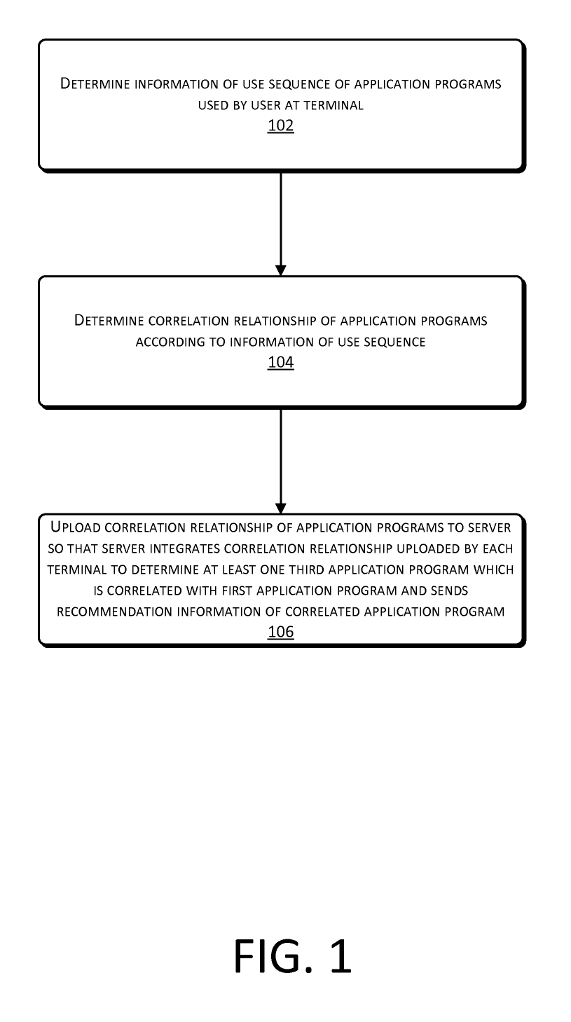

In a first example embodiment, from a perspective of the client, the present disclosure provides an example method of processing information related to application programs, as shown in FIG. 1, which may include following operations.

At 102, information of a use sequence of application programs used by a user at a terminal is determined.

In the first example embodiment, a client records use information of application programs used by the user so as to determine the use sequence of application programs used by the user. Thereafter, a correlation relationship of the application programs is determined and uploaded to a server. The server collects the information uploaded by each client for statistics and analysis.

For example, statistics of the use sequence of the application programs during a time period that the user uses the application programs are conducted to recommend a second or a third application program to the user. (To distinguish from the second application program, which is an application program that is determined to be correlated with the first application program by the terminal, an application program that is determined by the server to be correlated with the first application program is referred to as the third application program. The third application program is normally somewhat different from the second application program. However, in some cases these two application programs may be the same. For example, sometimes both the local terminal and the server may determine the same application program that is correlated with the first application program.) In other words, in general, there may be correlation relationships of the application programs. The correlation relationships may be generally observed by a user habit during a process that the user uses the application programs.

For example, time information when each application program is used may be directly recorded, and the use sequence of the application programs may be determined according to the recorded time information. Thereafter, a number of times that one application program is switched to another application program is calculated according to the determined use sequence of the application programs in the following operations. If the number of times of switching from the first application program to the second application program exceeds a predetermined threshold, then the first application program and the second application program are determined as having a correlation relationship.

It should be noted that the use sequence in this example embodiment may include a direct sequential relationship and an indirect sequential relationship. For example, assuming that the user has used application programs in a sequence of: an application program A, an application program B, and an application program C, the application program A and the application program B have a direct sequential relationship and the application program A and the application program C have an indirect sequential relationship. A user's behavior may be observed in the sequential relationship regardless of direct or indirect sequential relationship. Thus, the application program B and the application program C have the correlation relationship with the application program A with respect to the user.

For example, the time information when the application program is used may be referred to as a time that the application program is started, terminated, operated, etc. For instance, if the time information is referred to as the time of starting an application program, the time of starting each application program may be recorded respectively, and the use sequence of application programs may be determined according to a sequence of starting the application programs. For instance, when the user starts the application program A at time T1 and the application program B at time T2, the use sequence of application programs may be determined according to the sequence of T1 and T2, i.e., the application program A is firstly used and is then switched to the application program B. Similarly, if the user terminates the application program A at time T1 and then the user starts or terminates the application program B at time T2, then the use sequence of the application programs used by the user are also determined according to the sequence of T1 and T2, i.e., the use sequence of the application programs is from the application program A to the application program B. Certainly, there may be a plurality of second application programs that have such sequential correlation relationship. In other words, after using the first application program A, the user may use different second application programs, such as an application program C.

It should be noted that, when the user uses the application programs at a terminal device, the use sequence is considered as having a reference value only when the user starts the second application program within a short period of time after a termination of the first application program. For example, if the user starts the application program A, leaves a screen of the terminal device locked for a period of time, and then re-activates the terminal device to start using the application program B, then the application program B may not be considered as an application program that is usually used by the user after the application program A. However, if only the use sequence of the application programs is considered, this switching relationship between the application program A and the application program B may also be recorded. It thus will interfere with the determination of the switching relationship between application programs. Therefore, in order to avoid such misjudgment, a time threshold value may be preset prior to calculating the switching relationship between the application programs according to the use sequence of the application programs. If a time interval between the use times of two application programs exceeds the time threshold value, then the switching relationship between the two application programs is excluded in calculation.

Alternatively, for another example, use information of each application program used by the user at the terminal device may be recorded respectively when the client records the use information of the application programs used by the user. In a single use process, a use sequence of the application programs is determined according to the time information of the application programs that are used. In the same use process, the application programs that are used adjacently are determined as application programs that have a switching relationship. A number of times switching from the first application program to the second application program is calculated, and the calculated result from multiple use processes are accumulated to obtain a total number of times switching from the first application program to the second application program. Thereafter, the first application program and the second application program are determined as having the correlation relationship if the total number of times switching from the first application program to the second application program exceeds a predetermined value.

In other words, at the client, the same single use process of the user may be defined so that use information of the application programs in each use process may be recorded respectively. Accordingly, when the switching relationship among the application programs is calculated, the calculation is firstly conducted within each use process. Then the calculation result of each use process is accumulated to obtain a final number of times switching from one application program to another application program. It thus may be unnecessary to determine whether the time interval between two application programs in use exceeds a time threshold each time, thereby improving efficiency. In other words, when monitoring the user's use of the application programs, such monitoring may be based on each use process that the user uses the terminal device. The user's use time of each application program in each use process is recorded respectively. Thus, only the switching relationship among the application programs that are used in the same use process is recorded.

The definition of one single use process may be described as follows. For example, in a practical implementation, in order to avoid an incorrect operation, there is a scheme that allows an input device, e.g., a keyboard or a touch screen, of the terminal device to enter into a lock status when the user does not operate terminal device for a long time or after the user presses a lock button. In this situation, even if the user presses keyboard buttons or touches the touch screen intentionally, the operation will be considered as void. When the user needs to use the terminal device, he/she may perform an unlock operation firstly to activate the input device of the terminal device, and then use the application programs at the terminal device for different operations. Therefore, the unlock operation of the user may be considered as a start of a use process, and the start of the lock status of the input device of the terminal device may be considered as an end of the use process. In this way, the use process is defined so that the present techniques may record the application programs that the user use respectively in each use process and the use sequence of these application programs in each use process.

For example, after performing the unlock operation, the user firstly uses the application program A, the application program B, and then the application program C. Afterwards, the input device of the terminal enters into the lock status. Thus the client determines that the user's use sequence of the application programs in this use process is A, B, and C from the beginning to the end.

At 104, a correlation relationship of the application programs is determined according to the information of the use sequence.

As the use sequence of the application programs used by the user is determined, the correlation relationship of the application programs is determined according to the information of the use sequence. For example, when determining the correlation relationship of the application programs, a number of times switching from one application program to another application program in the use process of the application programs may be calculated according to the use sequence of application programs. When the number of times switching from the first application program to the second application program satisfies a preset condition such that the number of times exceeds a predetermined threshold value, the first application program and the second application program is determined as having a correlation relationship.

For example, when the user's use information is collected regardless of whether it belongs to the same use process or not, with respect to the same user, the use sequence of the application programs may be determined according to the time information of application programs that is used to obtain a sequence of application programs, such as: ABCDACBED, etc. Thereafter, the adjacent application programs are determined as having a switching relationship according to the use sequence of the application programs. Then a number of times switching from one application program to another application program is calculated. In other words, the switching relationships in the sequence such as A to B, B to C, C to D, etc. are recorded. Certainly, as described above, the present techniques may further determine whether the time interval of switching from the first application program to the second application program exceeds a predetermine time threshold to enhance an accuracy of the calculation.

If the time interval of switching from the first application program to the second application program does not exceed the predetermine time threshold, such switching is counted. In other words, if the time interval of switching from the first application program to the second application program does exceed the predetermine time threshold, such switching is not counted.

Thus, first of all, if two application programs are adjacent to each other in the use sequence, the present techniques further determine whether the time interval of use of these two application programs exceeds the time threshold. If the time interval exceeds the time interval, then the switching relationship of these two application programs will not be recorded. For instance, the application programs D and A are adjacent in the above example, while the time interval of use of these two applications is 20 minutes, which exceeds the preset time threshold (such as one minute, etc.). Therefore, the switching relationship between D and A is not recorded. Of course, D and A may have a switching relationship in the use information of other users. Finally, the number of times switching from one application program to another application program is obtained.

When the information of use sequence is determined at 102, relevant information whether each application program corresponds to the same use process may also be included and considered. Such information is analyzed to calculate a number of times switching from one application program to another application program. For example, the switching relationship of the application programs may be directly calculated according to the sequence of application programs and their corresponding use process information. For example, assuming there are application programs A, B, C, D, E at the terminal device, and multiple user sequences of a user U1 that the use the application programs at the terminal device are as follows:

ACBDE, EACE, DEAC, CADE, ACEDA

According to the above use information, a number of times that the user U1 switches from one application program to another application program is calculated as shown in Table 1 below.

TABLE 1

| | A | B | C | D | E |
|---|---|---|---|---|---|
| A | | | 4 | 2 | |
| B | | | | 1 | |
| C | 1 | 1 | | | 3 |
| D | 1 | | | | 2 |
| E | 2 | | | 1 | |

As shown in Table 1, the number of times that user U1 switches from the application program A to the application program C and the application programs D are 4 and 2 respectively, and the number of times that user U1 switches from the application program C to the application program E is 3. In other words, after the user U1 uses the application program A, there are four occurrences that the user U1 switches to the application program C, and there are twice occurrences that the user U1 switches to the application program D. After the user U1 uses the application program C, there are three occurrences that the user U1 switches to the application program E and the number of times switching to other application programs are all 1, which is relatively lower. Therefore the correlation between the application programs A and C and the correlation between the application programs C and E are relatively high. Furthermore, the information that there are a correlation relationship between the application programs A and C and a correlation relationship between the application programs C and E is uploaded to the server. The use information of the application programs used by other users may be calculated in the same way. For example, there is another user U2 in the system. The user U2 installs the following application programs: A, C, E, F, G, H, I. According to the use information of the application programs used by the user U2, a number of times switching from the application program A to the application program C is 5, and a number of times switching from the application program C to the application program E is 7.

According to the use information of the user U1 and the user U2, a total number of times switching from the application program A to the application program C is 9, and a total number of times switching from the application program C to the application program E is 10, and so on.

For example, according to the determined use sequence of the application programs, after the number of times of the users switching from the first application program to the second application program is calculated, at least one third application program that has a top ranking is determined as an application program correlated with the first application program, and is recommended to a user who has the first application program installed.

Furthermore, in order to avoid an undesired effect to the calculation by a user's random operations, a preset switching threshold may be determined so that only when a number of times switching from the first application program to the second application program exceeds the switching threshold, the second application program is determined as an application program correlated with the first application program in the use process of the user. In other words, only when the number of switching times is not smaller than the switching threshold, at least one second application program that has top ranking is determined as an application program correlated with the first application program.

At 106, the correlation relationship of the application programs is uploaded to a server so that the server integrates the correlation relationship uploaded by each terminal to determine at least one third application program which is correlated with the first application program and sends recommendation information of correlated application program.

After the correlation relationship of the application programs is determined by the client, it can be uploaded to the server so that the correlation relationship of the application programs uploaded by each client is collected by the server. Therefore the correlation relationships uploaded by each client are integrated for calculation to determine at least one third application program correlated with the first application program so that the correlated application program is recommended.

In other words, with respect to the server, the correlation relationship uploaded by a single client is not a final result. Instead, information of correlation relationships from each client is integrated to finally determine the third application programs that are correlated with the first application program. There may be a variety of methods for the server to integrate the correlation relationships, which are described in detail at the following third example embodiment.

Certainly, with respect to a particular application program, there may be a plurality of application programs that are calculated as correlated with such application program. After the at least one third application program correlated with the first application program is determined by the server, the recommendation information related to the third application program is provided to the user who has installed the first application program. The client receives the recommendation information of the correlated application program sent by the server, and then provides the at least one third application program correlated with the first application program to the user. For example, assuming the application program A is found having an correlation relationship with the application program C after the calculation, if the user has installed the application program A, recommendation information related to the application program C will be provided to the user as the application program C has a specific correlation relationship with the application program A and the user who has installed the application program A may also have a demand of using the application program C.

For example, with regard to the step of providing the recommendation information, the server may firstly determine whether a terminal device that has installed the first application program has installed the third application program as well. If the third application program is not installed, then the provided recommendation information is information of the third application program.

After the recommendation information of the correlated application program sent by the server is received by the client, recommendation information of the at least one third application program which is correlated with the first application program is provided to the user. For example, if the local terminal has already installed the first application program without the third application program, then the information of the third application program is recommended.

In other words, with respect to the recommendation information provided by the server, when the terminal has installed the first application program, the third application program which is correlated with the first application program is recommended to the terminal user for installation. Moreover, in a practical implementation, since the terminal has also operated a calculation with respect to the correlation relationship of the application programs, such calculated correlation relationship is more capable of reflecting the terminal user's behaviors of the installed application programs. For example, one application program is frequently used after another application program is used, and so on. Thus, in addition to using the recommendation information returned by the server to send the recommendation of installing the third application program which is correlated with the first application program to the user who has already installed the first application program, the present techniques also provide a recommendation to the user to use a second application program when the user is using the first application program according to the correlation relationship of the application programs calculated by the local terminal.

In a practical implementation, the terminal may provide an activation entry of the second application program, which is calculated by the local terminal as being correlated with the first application program, at the interface of the first application program that is used by the user. (The activation entry may be information such as an icon of the second application program that enables the user to switch from the first application program to the second application program by performing operations such as clicking, tapping or predetermined gestures etc.) When such activation entry is operated, the second application program is directly activated without requiring the user to look for the activation entry such as the icon of the second application program at the main interface.

In addition, for example, when information of the entry of the at least one second application program or third application program which is correlated with the first application program is provided to the user by the client, the recommendation information of the second application program may be provided to the user in accordance with the correlation relationship calculated by the local terminal only. Alternatively, for another example, since the recommendation information of the third application program returned by the server is integrated with a plurality of calculated results from the clients, such information may reflect a more comprehensive correlation relationship of the application programs. Therefore the recommendations of the second application program and the third application program may be integrated during a practical implementation to determine the entry of application program(s) to be provided to the user. For example, assuming that the second application programs B and C are correlated with the first application program A according to the calculating result of the local terminal, and the third application programs B and D are correlated with the first application program A according to the correlation relationship provided by the server, when adding entry information at the interface of the first application program A, the terminal may only add entry information of the application program B without adding entry information of the application program C, as the application program C is not correlated with the application program A according to the calculated result of the server. In other words, the recommendation information returned by the server may be used for verifying the calculating result of the local terminal.

For example, in the step that the client determines the user's use sequence of the application programs, it usually treats users that use the same terminal device as the same user for calculating a user's behavior. However, in the practical implementation, since there may be multiple users who use the same terminal device, the calculated result may not be able to reflect a real user's behavior if the users are not distinguished apart, thereby further affecting the determination of the correlation relationship of the application programs and the recommendation information of the entry for the users.

Therefore, in the practical implementation, a user's use sequence of application programs installed at the terminal may be calculated according to log-in information of each user, so that the correlation relationships of the application programs may be determined according to the use sequence of different users. In the following step that adds the entry of the second application program correlated with the first application program to the interface of the first application program, the present techniques find out the correlation relationship of the application programs which is determined according to the use information of the current user according to the user's login information. Thereafter, the present techniques perform the recommendation of the entry information. In a practical implementation, the operation of the application programs used by the user may be monitored when the user logs in. For instance, a surveillance application server may be provided for performing an administration service for the user's account. A user is able to register his/her own account to the server and login with his/her own account information each time when he/she uses the terminal device. In this way, different users may be distinguished from each other according to the log-in information, and be monitored and calculated respectively even if there are different users using the same terminal device.

Above all, in this example embodiment, the present techniques determine the application programs probably having correlation relationship according to the relationship of the use sequence of the application programs during the user's using process, and further provide recommendation information related to the application program to the user according to the correlation relationship of the application programs, thereby improving the effectiveness of the recommendation.

The present disclosure also provides a second example embodiment. According to the above description, if the user often uses the second application program after using the first application program, then this sequential relationship may be deemed as a behavior of the user. In other words, each user's use behavior of the application programs may be calculated in accordance with the correlation relationship of the application programs uploaded by the client. Furthermore, two users having the same or similar use behavior may be recommended to become friends with each other. Therefore, at least one second user who is similar to the first user may be further determined after the server receives the correlation relationship of the application programs uploaded by the client, and recommendation information related to a similar user is sent. According to this example embodiment, such friend recommendation based on the same or similar use behavior is able to increase the accuracy of recommendation and effectively prevent the waste of resource for calculation and harassment to the user caused by inaccurate recommendation.

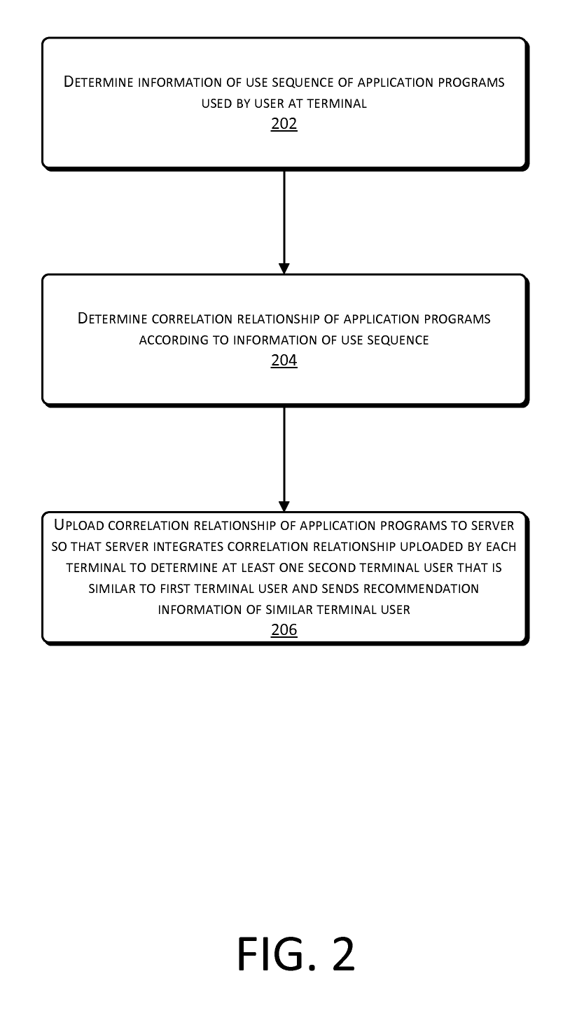

As shown in FIG. 2, the present disclosure also provides an example method of recommending similar user information in accordance with a second example embodiment of the present disclosure.

At 202, information of a use sequence of application programs used by a user at a terminal is determined. At 204, a correlation relationship of the application programs is determined according to the information of the use sequence. At 206, the correlation relationship of the application programs is uploaded to a server so that the server integrates the correlation relationship uploaded by each terminal to determine at least one second terminal user that is similar to a first terminal user and sends recommendation information of similar terminal user.

For example, when determining at least one second terminal user who is similar to the first terminal user, a similarity between the correlation relationships of the application programs uploaded by two users is compared. For instance, with respect to a first terminal and a second terminal, a number of correlated application program pairs uploaded by the first user is M1 and a number of correlated application program pairs uploaded by the second user is M2. Such number is calculated respectively. The correlated application program pairs uploaded by the first terminal and the correlated application program pairs uploaded by the second terminal are compared to obtain a number of identical correlated application program pairs, which is M3. The similarity between these two terminals may be obtained by calculating M3/(M1+M2). The result of the calculation is compared with a threshold value. The first terminal user is determined as similar to the second terminal user if the calculated similarity exceeds the threshold value. Of course, in a practical implementation, other methods may be used to determine the similarity of two users. The recommendation information may be sent to each of the two terminal users after the first terminal user and the second terminal user are determined as similar.

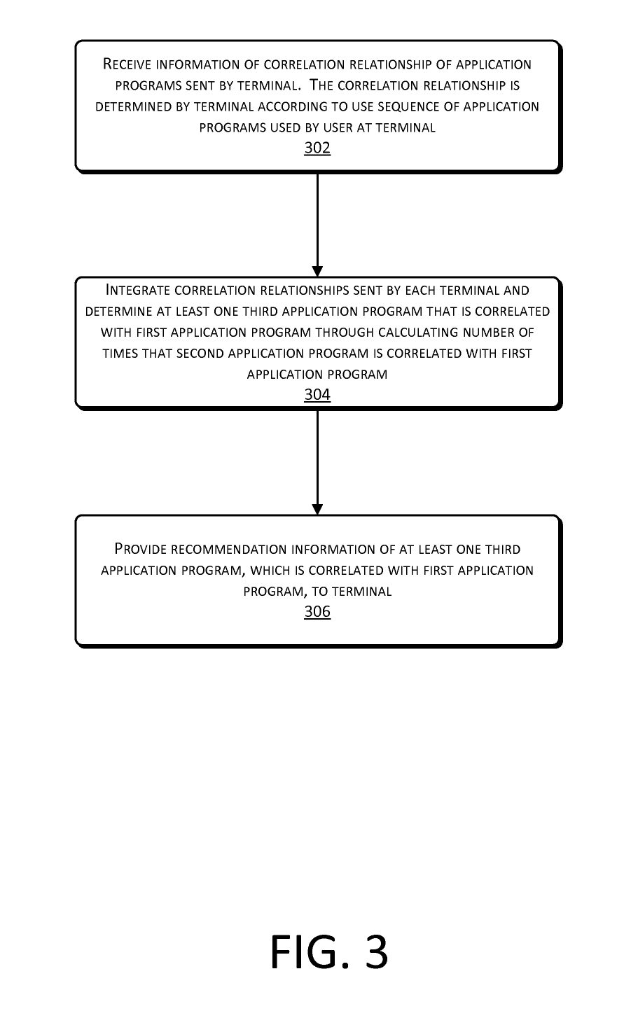

The first example embodiment and the second example embodiment are described with respect to the client, and the third example embodiment is described with respect to the server. As shown in FIG. 3, a third example embodiment of the present disclosure provides an example method of providing recommendation information of an application program.

At 302, information of a correlation relationship of the application programs sent by a terminal is received. The correlation relationship is determined by a terminal according to a use sequence of the application programs used by the user at the terminal.

As step 302 has already been described in detail in the first example embodiment, the description is not detailed herein.

At 304, the correlation relationships sent by each terminal is integrated and at least one third application program that is correlated with a first application program is determined by calculating a number of times that one or more second application programs that are correlated with the first application program is calculated.

As described above, from the perspective of the server, the correlation relationship uploaded from a single client is not the final result, and should be integrated with all correlation relationship information from every client to determine which application programs are the third application programs correlated with the first application program. Specifically, in the step of integrating, the same correlation relationship of the application programs uploaded by each client may be accumulated for obtaining an accumulated result to determine application programs whose accumulated results match a preset condition as correlated application programs. For example, the correlation relationships uploaded by a client C1 include A and C, D and E, A and D, etc., and the correlation relationships uploaded by a client C2 include A and C, D and E, A and E. Therefore, with respect to these two users, the correlation relationship between A and C is accumulated twice, the correlation relationship between C and D is also accumulated twice. Accumulation of the correlation relationships between A and D and that between A and E are both once. Other correlation relationships uploaded by other clients may be accumulated according to the manner described above. Eventually, a number of times that one application program is correlated with another is calculated. If the number exceeds a specific threshold value, then the two application programs are determined as having the correlation relationship.

At 306, recommendation information of the at least one third application program, which is correlated with the first application program, is provided to the terminal.

There may be various methods of providing recommendation information to the terminal. For example, the server may send information including identification of the application programs that are determined as having the correlation relationship and the information of the correlation relationship between the first application program and the at least one third application program to the client. The client provides recommendation information to the user according to the application programs installed on the terminal device. For example, when the server has analyzed that the correlation relationship exists between the application program A and application program C and between the application program C and the application program E, these correlation relationships are sent to each client. If a terminal device of a client finds that the application program A is installed while the application program C is not, then the application program C is recommended to the user.

Alternatively, in another implementation, the following steps may be executed by each client in order to allow the server to provide recommendation information to each user. Each client of each user uploads a list of the application programs installed on the terminal device to the server. Alternatively, the server inquires the installation records and/or deleting records of application programs from the clients. Alternatively, the sever end inquires backup records of the application programs from the clients. Thus the server is able to obtain the information of application programs that are installed on every individual terminal device. After the step of determining the application programs that have the correlation relationship, the sever determines that the terminal devices should receive the recommendation information according to the previously determined information of correlation relationships, and directly sends or pushes the recommendations to the corresponding terminal devices. For instance, the server determines whether a particular terminal device having the first application program is installed with the third application program or not. If the third application program is not installed, then a recommendation to install the third application program is provided to the user. If the third application program is installed, the recommendation information of using the at least one third application information is provided to the user. For example, assuming the server has analyzed that there are the correlation relationship between the application programs A and C, and the correlation relationship between application programs C and E, and the server finds, according to the list of installed application programs uploaded by each client, that a particular terminal device is installed with the application program A but is not installed with the application program C, and then recommends the corresponding user to install the application program C directly.

For example, the client may acquire the list of installed application programs by calling a system interface, and then uploads the list to the server.

It should be noted that, the server determines at least one third application program that has the correlation relationship with the first application program according to the correlation relationships uploaded by each client. The extent of closeness of the correlation relationship with the first application program may be different for each third application program. For example, if a correlation relationship between the application programs A and C is uploaded by 100 clients, a correlation relationship between the application programs A and D is uploaded by 50 clients, and a predetermined threshold value is 30, then both of the application programs C and D are determined as having the correlation relationship with the application program A by the server. However, a closeness degree of correlation relationship between the application programs A and C is higher than that between the application programs A and D. Therefore, when recommending to the client, for example, the third application programs that have top rankings in the closeness degree of correlation relationships with the first application program may be recommended to the user.

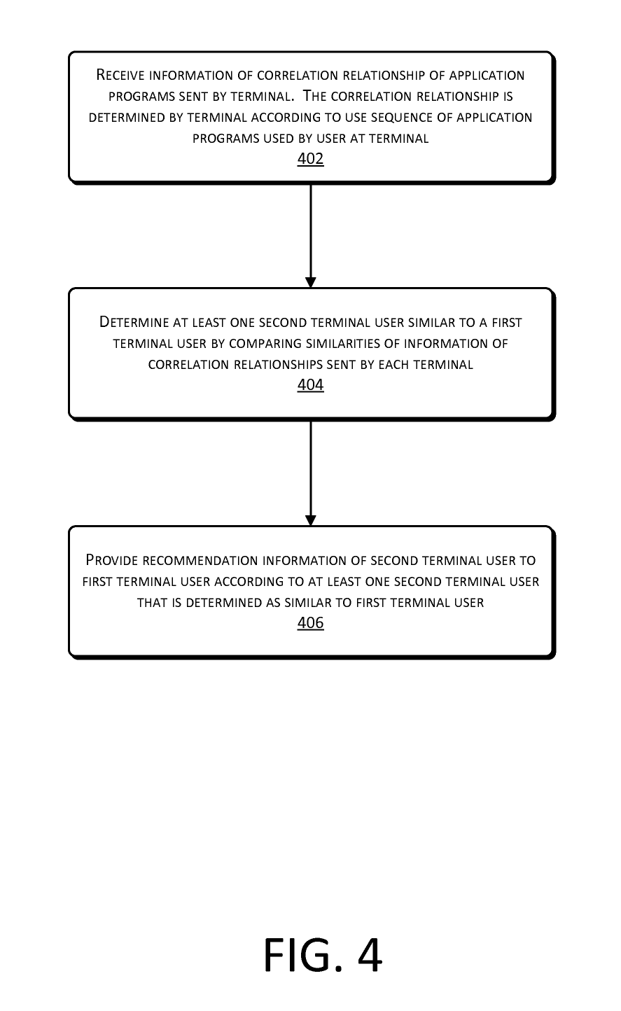

The implementation of recommending correlated application programs by the server is described in the third example embodiment. In a fourth example embodiment, the recommendation of similar terminal users from the perspective of the server is described. As shown in FIG. 4, an example method for providing recommendation information of a similar user according to the fourth example embodiment is provided from the perspective of the server.

At 402, information of a correlation relationship of the application programs sent by a terminal is received. The correlation relationship is determined by a terminal according to a use sequence of the application programs used by the user at the terminal.

At 404, at least one second terminal user similar to a first terminal user is determined by comparing similarities of the information of the correlation relationships sent by each terminal.

At 406, according to the at least one second terminal user that is determined as similar to the first terminal user, recommendation information of the second terminal user is provided to the first terminal user.

For example, if the similarity between users U1 and U2 in the behavior of using the application programs satisfies a preset condition, these two users may be recommended to each other, such as recommending the user U1 to add the user U2 as a friend, and at the same time recommending the user U2 to add the user U1 as a friend. A reason of recommendation may be displayed while the recommendation information is provided to these users, such as “the user frequently uses the same application program as you do”, and so on.

For example, the recommended user may be a user registered in a system of the present disclosure. The server may push the recommendation information according to information such as an account name of the user and so on. After a user has added another user as a friend, the system provides instant messaging function so that they may communicate with each other.

The related details of the fourth example embodiment have been described in the first and the second example embodiments. The specific details of implementation may be referred to in the descriptions in the previous example embodiments, and thus are not detailed herein.

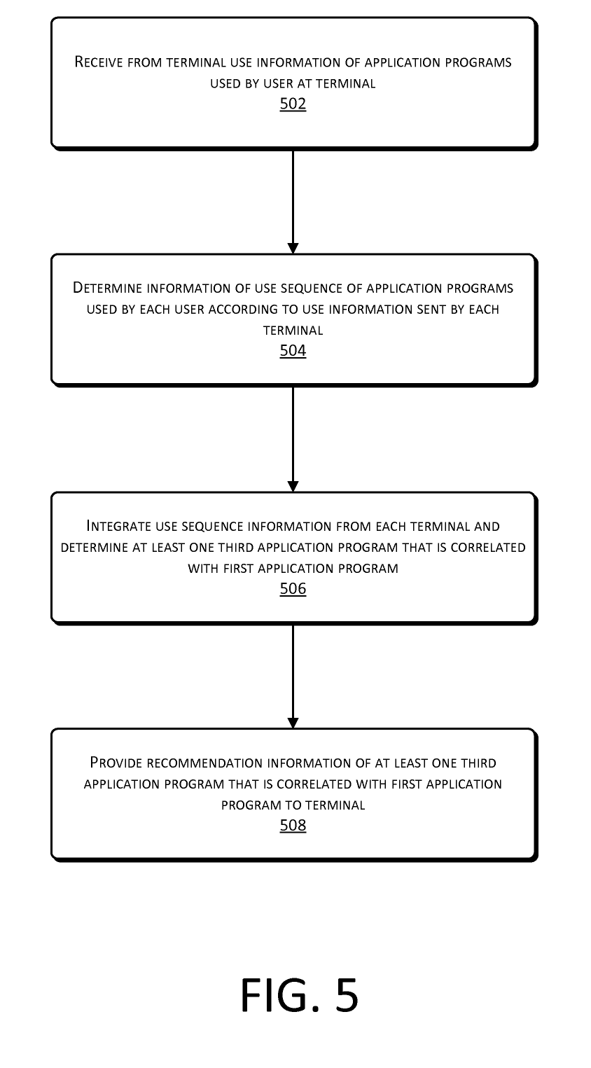

From the first to the fourth example embodiments, the client analyzes the determined use sequence of the application programs, determines the correlation relationships of the application programs, and then uploads the correlation relationships to the server for statistics. The server finally determines the application programs with the correlation relationship and recommends the correlated application programs to the user. Alternatively, after the server determines a similarity of users, the server recommends the similar users. In a fifth example embodiment, the client may just collect use information of operations to the application programs by the user, and directly upload the use information to the server. The server determines the use sequence of the application programs used by the users according to the use information and determines the correlation relationship of the application programs. Firstly, the example method in the fifth example embodiment is described as follows from the perspective of the server. As shown in FIG. 5, the present disclosure provides an example method for providing recommendation information of an application program according to the fifth example embodiment.

At 502, use information of application programs used by a user at a terminal is received from the terminal.

For example, the use information of the application program may refer to use time information of the application program, such as the time when the application program is opened, paused, or closed. The identification of the application program and its corresponding use time information may be sent to the server when the user opens, pauses, or closes the application program. Alternatively, the client may record the identification of the application program and its corresponding use time information in a form of a log, and send a log file including the use information to the server. In other words, the use information of the application programs is sent to the server in a form of log.

At 504, information of use sequence of the application programs used by each user is determined according to the use information sent by each terminal.

For example, the use sequence of the application programs may be determined with respect to each terminal user according to the use time information of the application programs sent by each terminal. The corresponding calculation method may be the same as those described in the first example embodiment.

At 506, the use sequence information from each terminal is integrated and at least one third application program that is correlated with a first application program is determined.

Since the use sequence of application programs used by the user has been determined, the present techniques firstly, based on a single user, calculate a number of time switching from one application program to another application program during his/her process of using the applications programs, and accumulate the calculated results of each user to obtain a total number of times switching from one application to another application. In a practical implementation, for example, in the step of calculating the number of times switching from one application to another application, a number of times switching from one application program to another application program for each user is calculated respectively at first, and then the calculated number of times of each user is added to obtain a total number of times switching from one application to another application based on the information of a massive number of users. If the total number of times exceeds a preset threshold value, then the two application programs are determined as having the correlation relationship.

For example, in the step of calculating the number of times switching from one application program to another application program, the use information of each user may be directly mixed together for calculation and analysis. In other words, the server does not need to distinguish different users after collecting the information uploaded by the clients. Instead, the server only needs to obtain which application programs are used and their use sequence in the use processes. For example, based on the previous example, the application programs that are installed on the terminal devices of the user U1 and the user U2 include: A, B, C, D, E, F, G, H, and I. A number of times switching form one application program to another application program may be calculated in accordance with the method as shown in the Table 1.

At 508, recommendation information of the at least one third application program that is correlated with the first application program is provided to the terminal.

The details of providing recommendation information to the terminal at this step are similar to those in the third example embodiment, and thus are not detailed herein.

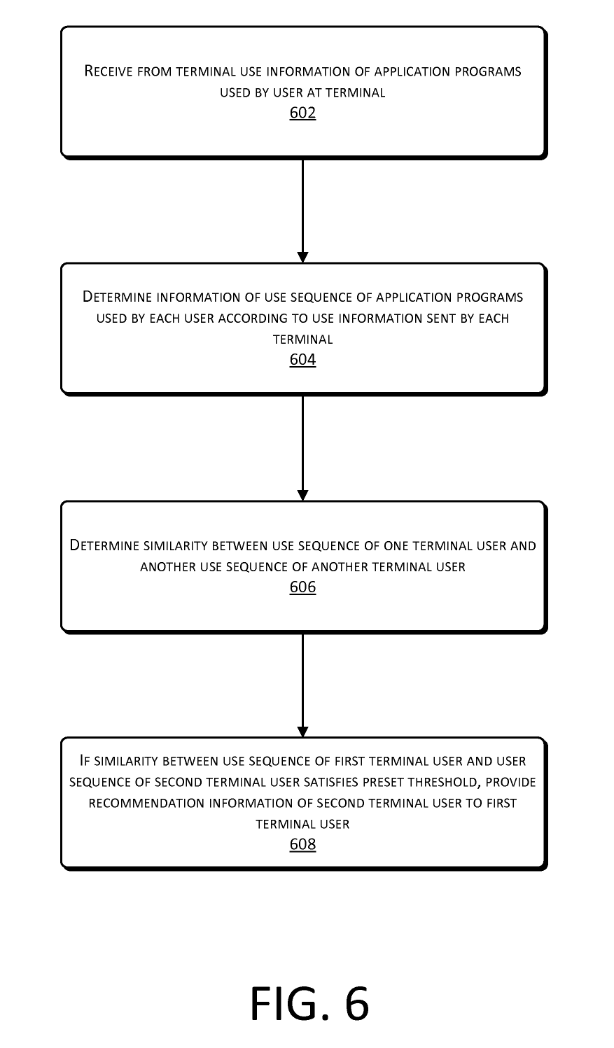

A sixth example embodiment is similar to the fifth example embodiment. The difference is that the server, after determining the use sequence of the application programs used by each terminal user, determines the similarity of the terminal users by directly using the use sequence of different terminal users without the necessity of determining the correlation relationship of the application programs in advance. As shown in FIG. 6, the present disclosure provides an example method for providing recommendation information to the user from the perspective of the server.

At 602, use information of application programs used by a user at a terminal is received from the terminal.

At 604, information of use sequence of the application programs used by each user is determined according to the use information sent by each terminal.

The operations at 602 and 604 are similar to those at 502 and 504. The details of determining the use sequence of the application programs are described in the first embodiment, which will detail herein.

At 606, a similarity between a use sequence of one terminal user and another use sequence of another terminal user is determined.

When determining the similarity of the use sequences of the application programs between two users, a numbers of times switching from one application program to another application program is calculated respectively for each user. The similarity between the use sequences of the first user and the use sequences of the second user is determined according to the number of times switching from the first application program to the second application program for the first user, and the number of times switching from the first application program to the second application program for the second user. In other words, it is somewhat different from the recommendation of the application program according to the first example embodiment. According to the fifth example embodiment, the number of times that the users switch from one application program to another application program is calculated respectively according to the application programs used by each user. The similarity between the terminal users in using the application programs is then further determined. For example, after the calculation, a user U1 is found having a largest number of times switching from the application program A to the application program C in the process of using a terminal device among his/her use, and a user U2 is also found having a largest number of times switching from the application program A to the application program C among his/her use, then the user U1 and the user U2 have a relatively higher similarity in using the application programs. Of course, in a practical implementation, after the use sequence of the application programs used by each user is determined, the similarity between the two users in using the application programs may be determined by other methods.

At 608, if the similarity between the use sequence of the first terminal user and the user sequence of the second terminal user satisfies a preset threshold, recommendation information of the second terminal user is provided to the first terminal user and/or recommendation information of the first terminal user is provided to the second terminal user.

Thus, according to this example embodiment, after the use information of the application programs used by the user is collected, the present techniques not only provide application programs that the user may be interested but also recommendation information of another user so that the user may find another user that has similar behavior in using the application programs.

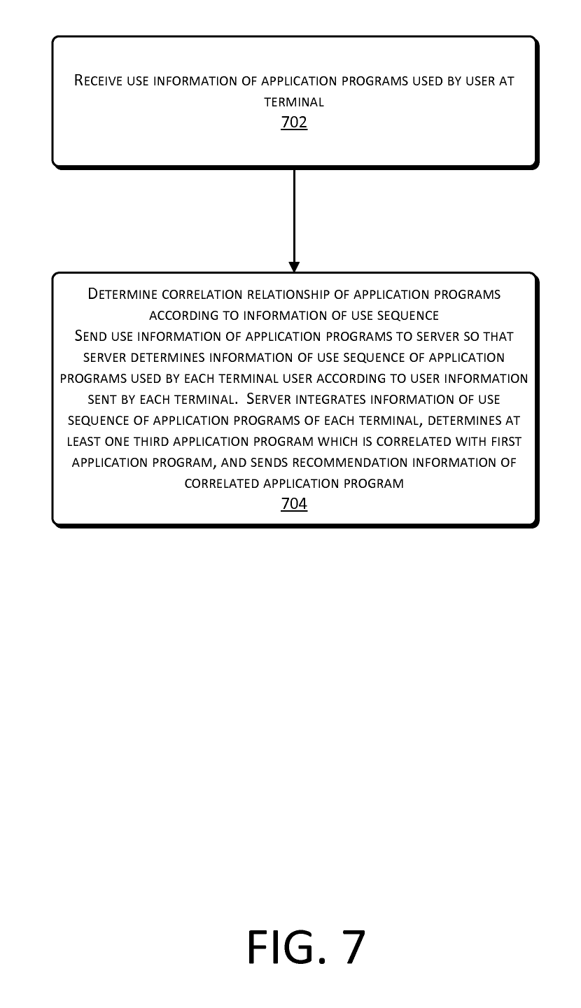

Corresponding to the fifth example embodiment, the present disclosure also provides an example method of recommending related information of an application program from the perspective of the client, as shown in FIG. 7.

At 702, use information of application programs used by a user at a terminal is received.

At 704, the use information of the application programs is sent to a server so that the server determines information of a use sequence of application programs used by each terminal user according to the user information sent by each terminal. The server integrates the information of the use sequence of the application programs of each terminal, determines at least one third application program which is correlated with a first application program, and sends recommendation information of correlated application program.

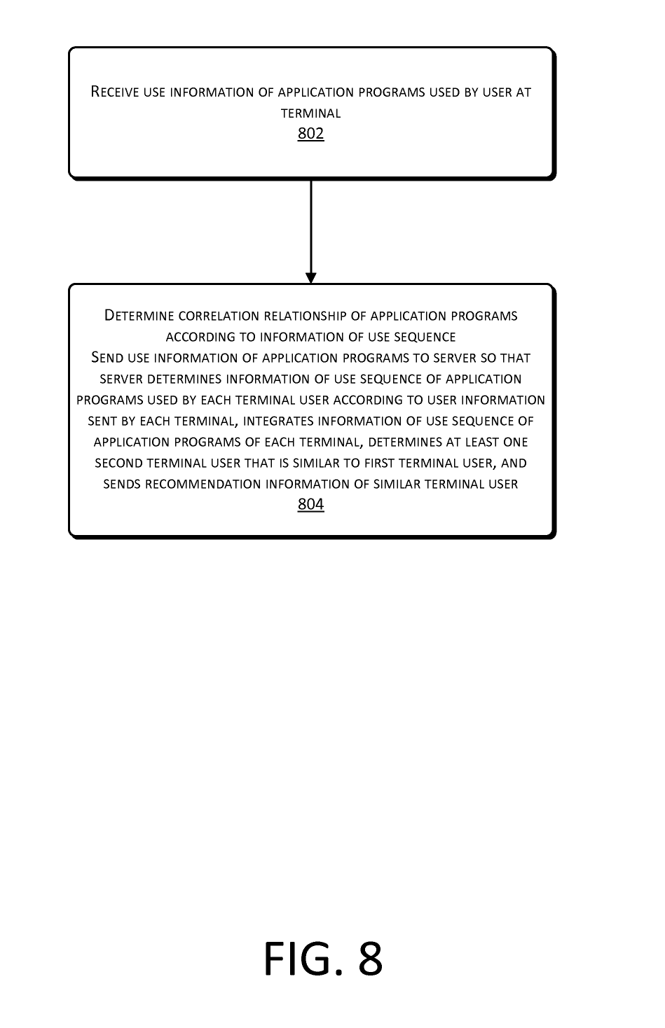

Corresponding to the sixth example embodiment, the present disclosure also provides an example method of providing recommendation information of similar use information from the perspective of the client, as shown in FIG. 8.

At 802, use information of application programs used by a user at a terminal is received.

At 804, the use information of the application programs is sent to a server so that the server determines information of a use sequence of application programs used by each terminal user according to the user information sent by each terminal. The server integrates the information of the use sequence of the application programs of each terminal, determines at least one second terminal user that is similar to a first terminal user, and sends recommendation information of a similar terminal user.

The specific details of the seventh and the eighth example embodiments may be referred to those in the fifth and the sixth embodiments, which are not detailed herein.

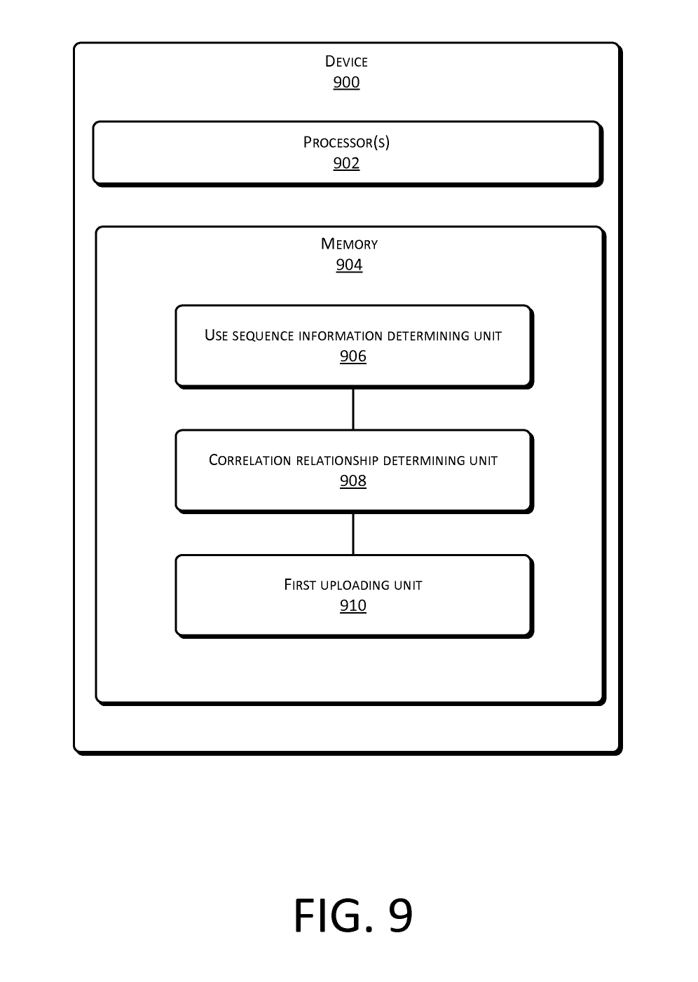

Corresponding to the example method of recommending the information related to the application programs in the first example embodiment, the present disclosure also provides an example device for recommending the information related to the application program. Such device may be located at the client. Referring to FIG. 9, an example device 900 may include one or more processor(s) or data processing unit(s) 902 and memory 904. The memory 904 is an example of computer-readable media. As used herein, “computer-readable media” includes computer storage media and communication media. Computer storage media includes volatile and non-volatile, removable and non-removable media implemented in any method or technology for storage of information such as computer-executed instructions, data structures, program modules, or other data. In contrast, communication media may embody computer-readable instructions, data structures, program modules, or other data in a modulated data signal, such as a carrier wave. As defined herein, computer storage media does not include communication media. The memory 904 may store therein a plurality of units including a use sequence information determining unit 906, a correlation relationship determining unit 908, and a first uploading unit 910. The use sequence information determining unit 906 determines information of a use sequence of application programs used by a user at a terminal. The correlation relationship determining unit 908 determines a correlation relationship of the application programs according to the information of the use sequence. The first uploading unit 910 uploads the correlation relationship of the application programs to a server so that the server integrates the correlation relationship uploaded by each terminal to determine at least one third application program which is correlated with the first application program and sends recommendation information of correlated application program.

For example, when providing information to the user, the device 900 may further include a first recommending unit (not shown in the FIGs). The first recommending unit receives the recommendation information of the correlated application program from the server and provides the recommendation information of the second application program to the user if the first application program is installed at the local terminal while the second application program is not installed at the local terminal.

Alternatively, the device 900 may also include a second recommending unit (not shown in the FIGs). The second recommending unit, according to information of the second application program which is determined by the local terminal as having the correlation relationship with the first application program, adds entry information of the correlated second application program to an operation interface of the first application program so that the second application program is operated when the user conducts a designed operation to the entry information of the correlated second application program.

To distinguish different users who use the same terminal, the use sequence determining unit 906 may calculate the use sequence of the application programs used by each user at the terminal respectively according to the login information of each user.

The correlation relationship determining unit 908 may determine the correlation relationship of the applications programs according to the use sequence of different users. Correspondingly, the second recommending unit adds the entry information of the correlated second application program to the operation interface of the first application program according to the login information of the users and the second application program that is determined by the local terminal as having the correlation relationship with the first application program.

For example, the correlation relationship determining unit 908 may include a switching times calculating sub-unit and a determining sub-unit. The switching time calculating unit determines adjacent application programs as having a switching relationship according to the use sequence and calculates a number of times that the first application program is switched to the second application program. The determining sub-unit determines that the first application program and the second application program have the correlation relationship if the number of times that the first application program is switched to the second application program satisfies a preset condition.

For example, the use sequence determining unit 906 may include a time information recording sub-unit and a sequence information determining sub-unit. The time information recording sub-unit records time information of each application program that has been used. The sequence information determining sub-unit determines the use sequence of the application programs according to the time information of each application programs that has been used.

For another example, in a practical implementation, the use sequence determining unit 906 may further include a deciding unit that determines a time interval of switching from the first application program to the second application program exceeds a predetermine time threshold, and count a switching operation if the time interval does not exceed the time threshold.

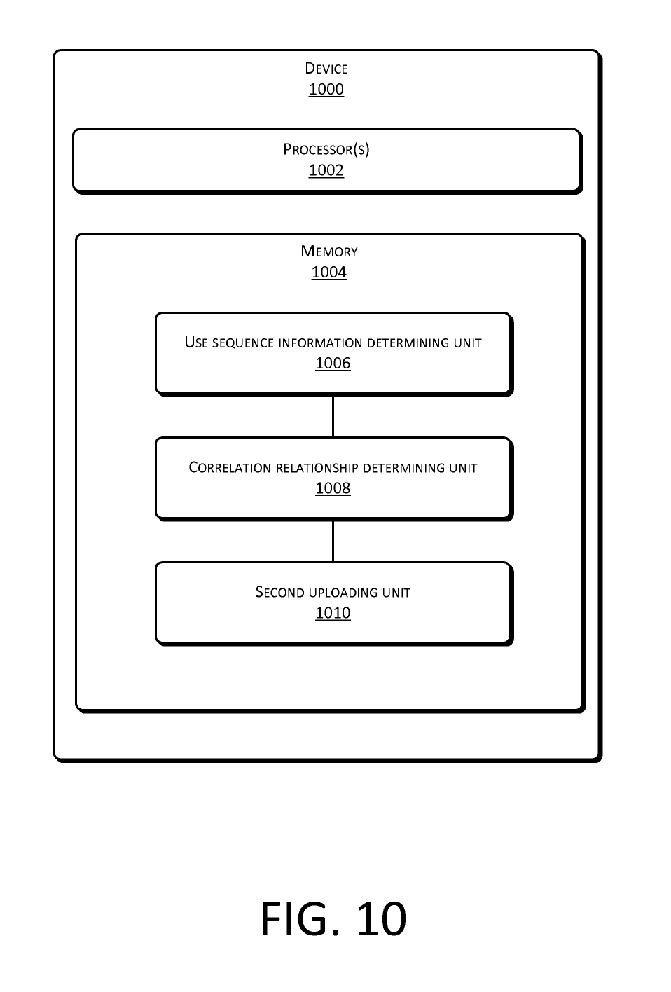

Corresponding to the example method of recommending the information related to a similar user in the second example embodiment, the present disclosure also provides an example device of recommending the information related to a similar user, as shown in FIG. 10. Such device may be located at the client. Referring to FIG. 10, an example device 1000 may include one or more processor(s) or data processing unit(s) 1002 and memory 1004. The memory 1004 is an example of computer-readable media. The memory 1004 may store therein a plurality of units including a use sequence determining unit 1006, a correlation relationship determining unit 1008, and a second uploading unit 1010.

The use sequence information determining unit 1006 determines information of a use sequence of application programs used by a user at a terminal. The correlation relationship determining unit 1008 determines a correlation relationship of the application programs according to the information of the use sequence. The second uploading unit 1010 uploads the correlation relationship of the application programs to a server so that the server integrates the correlation relationship uploaded by each terminal to determine at least one second terminal user that is similar to a first terminal user and sends recommended information of the similar terminal user.

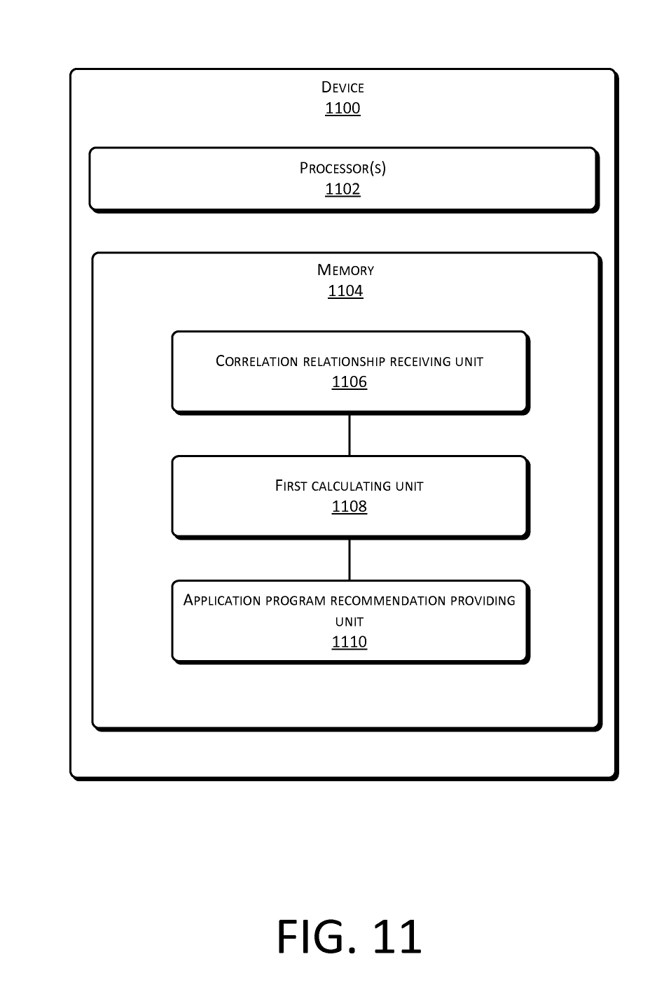

Corresponding to the example method of providing recommendation information of an application program in the third example embodiment, the present disclosure also provides an example device of providing recommendation information of an application program, as shown in FIG. 11. Such device may locate at the server. Referring to FIG. 11, an example device 1100 may include one or more processor(s) or data processing unit(s) 1102 and memory 1104. The memory 1104 is an example of computer-readable media. The memory 1104 may store therein a plurality of units including a correlation relationship receiving unit 1106, a first calculating unit 1108, and an application program recommendation providing unit 1110. The correlation relationship receiving unit 1106 receives information of a correlation relationship of the application programs sent by a terminal. The correlation relationship is determined by a terminal according to a use sequence of the application programs used by the user at the terminal. The first calculating unit 1108 integrates the correlation relationships sent by each terminal, calculates a number of times that a third application program is correlated with the first application program, and determines at least one third application program that is correlated with the first application program. The application program recommendation providing unit 1110 provides recommendation information of the at least one third application program to a terminal.

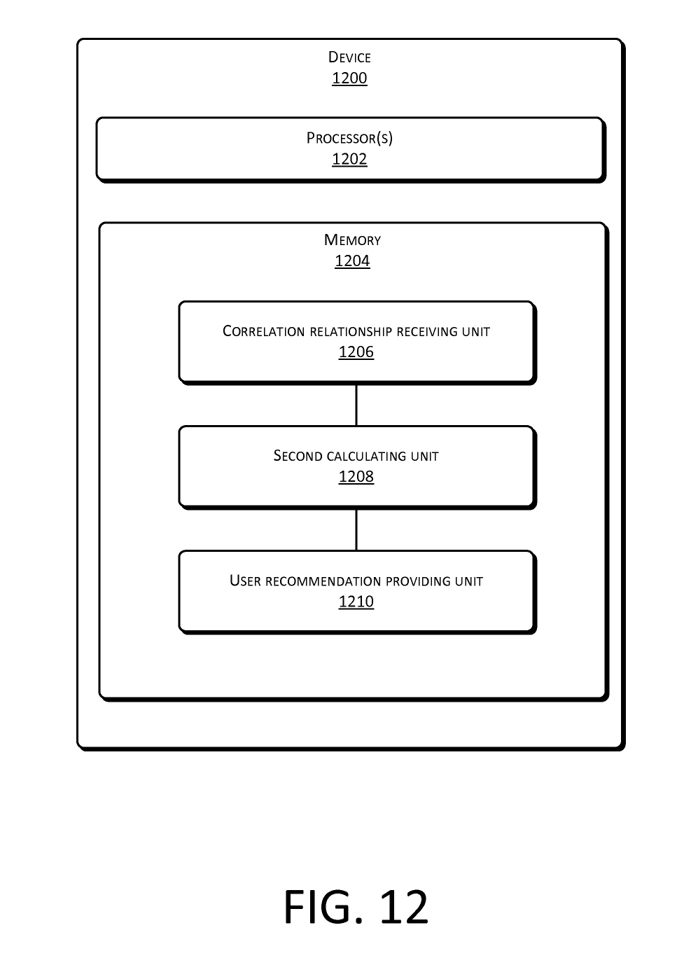

Corresponding to the example method of providing recommendation information of similar use information in the fourth example embodiment, the present disclosure also provides an example device of providing recommendation information of similar use information, as shown in FIG. 12. Such device may locate at the server. Referring to FIG. 12, an example device 1200 may include one or more processor(s) or data processing unit(s) 1202 and memory 1204. The memory 1204 is an example of computer-readable media. The memory 1204 may store therein a plurality of units including a correlation relationship receiving unit 1206, a second calculating unit 1208, and a user recommendation providing unit 1210.

The correlation relationship receiving unit 1206 receives information of a correlation relationship of the application programs sent by a terminal. The correlation relationship is determined by a terminal according to a use sequence of the application programs used by the user at the terminal. The second calculating unit 1208 determines at least one second terminal user similar to a first terminal user by comparing similarities of the correlation relationships sent by each terminal. The user recommendation providing unit 1210, according to the at least one second terminal user that is determined as similar to the first terminal user, provides recommendation information of the second terminal user to the first terminal user.

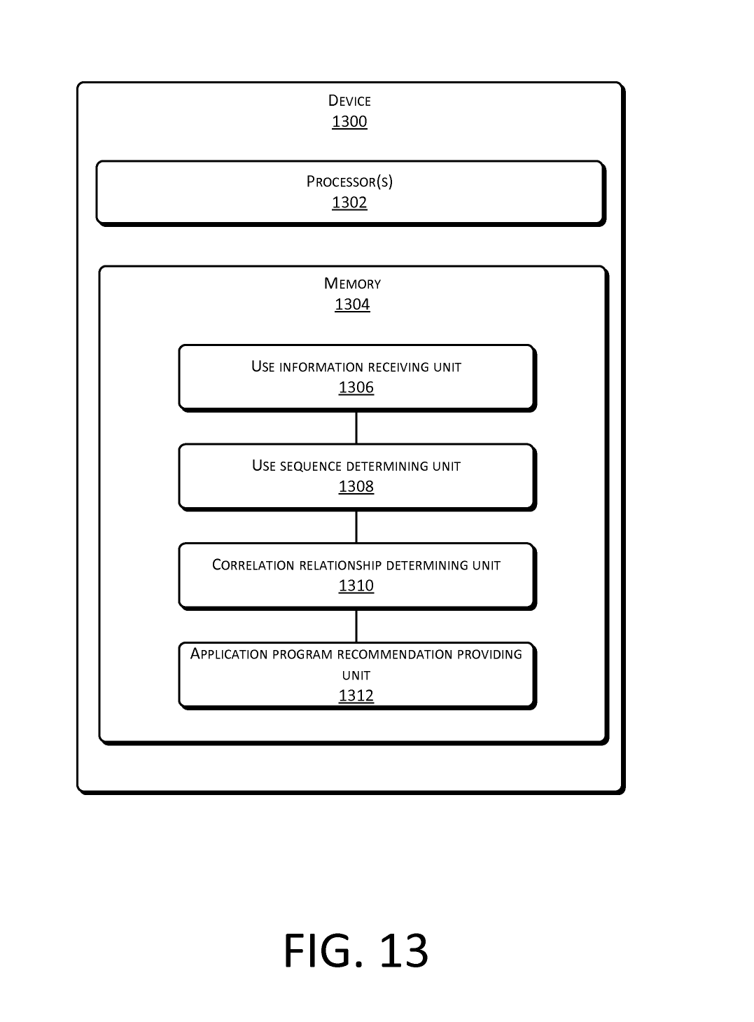

Corresponding to the example method of providing recommendation information of an application program in the fifth example embodiment, the present disclosure also provides an example device of providing recommendation information of an application program, as shown in FIG. 13. Such device may locate at the server. Referring to FIG. 13, an example device 1300 may include one or more processor(s) or data processing unit(s) 1302 and memory 1304. The memory 1304 is an example of computer-readable media. The memory 1304 may store therein a plurality of units including a use information receiving unit 1306, a use sequence determining unit 1308, a correlation relationship determining unit 1310, and an application program recommendation providing unit 1312.

The use information receiving unit 1306 receives use information of application programs used by a user at a terminal from the terminal. The use sequence determining unit 1308 determines information of use sequence of the application programs used by each user according to the use information sent by each terminal. The correlation relationship determining unit 1310 integrates the use sequence information from each terminal and determines at least one third application program that is correlated with a first application program. The application program recommendation providing unit 1312 provides recommendation information of the at least one third application program that is correlated with the first application program to the terminal.

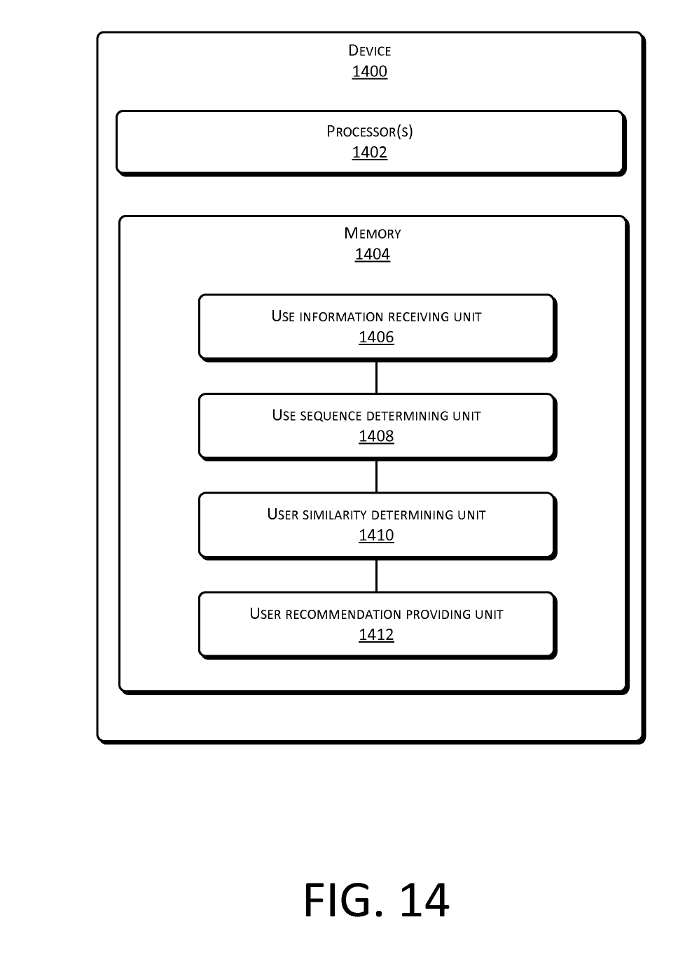

Corresponding to the example method of providing user recommendation information in the sixth example embodiment, the present disclosure also provides an example device of providing user recommendation information, as shown in FIG. 14. Such device may locate at the server. Referring to FIG. 14, an example device 1400 may include one or more processor(s) or data processing unit(s) 1402 and memory 1404. The memory 1404 is an example of computer-readable media. The memory 1404 may store therein a plurality of units including a use information receiving unit 1406, a use sequence determining unit 1408, a user similarity determining unit 1410, and a user recommendation providing unit 1412.

The use information receiving unit 1406 receives use information of application programs used by a user at a terminal from the terminal. The use sequence determining unit 1408 determines information of use sequence of the application programs used by each user according to the use information sent by each terminal. The user similarity determining unit 1410 determines a similarity between a use sequence of one terminal user and another use sequence of another terminal user. The user recommendation providing unit 1412, when the similarity between the use sequence of one terminal user and another use sequence of another terminal user satisfies a preset threshold, provides recommendation information of the second terminal user to the first terminal user.

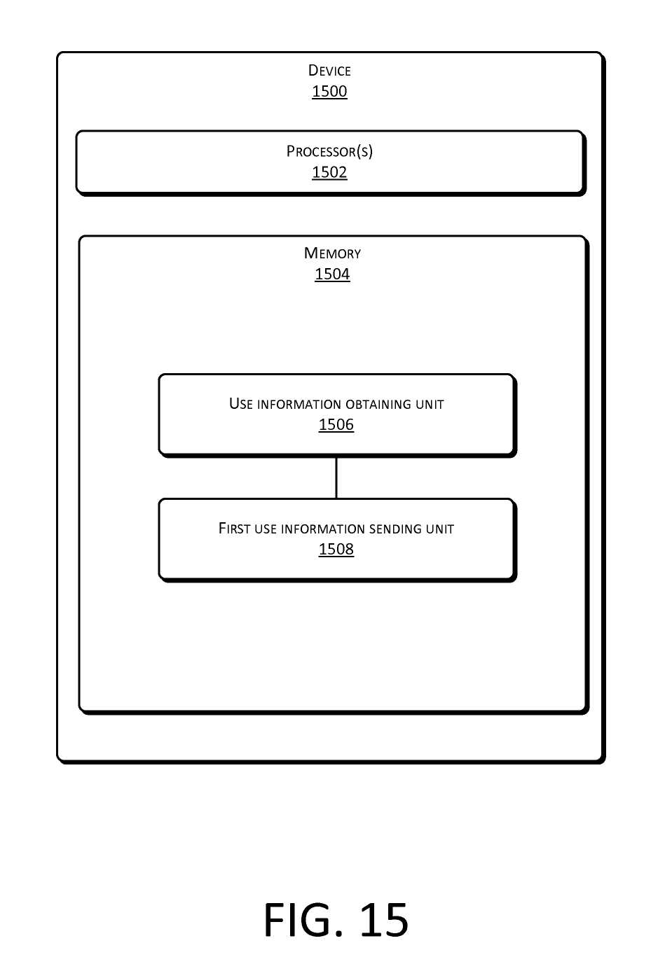

Corresponding to the example method of recommending related information of an application program in the seventh example embodiment, the present disclosure also provides an example device of recommending related information of an application program, as shown in FIG. 15. Such device may locate at the client. Referring to FIG. 15, an example device 1500 may include one or more processor(s) or data processing unit(s) 1502 and memory 1504. The memory 1504 is an example of computer-readable media. The memory 1504 may store therein a plurality of units including a use information obtaining unit 1506 and a first use information sending unit 1508.

The use information obtaining unit 1506 obtains use information of application programs used by a user at a terminal. The use information sending unit 1508 sends the use information of the application programs to a server so that the server determines information of a use sequence of application programs used by each terminal user according to the user information sent by each terminal, integrates the information of the use sequence of the application programs of each terminal, determines at least one third application program which is correlated with a first application program, and sends recommendation information of correlated application program.

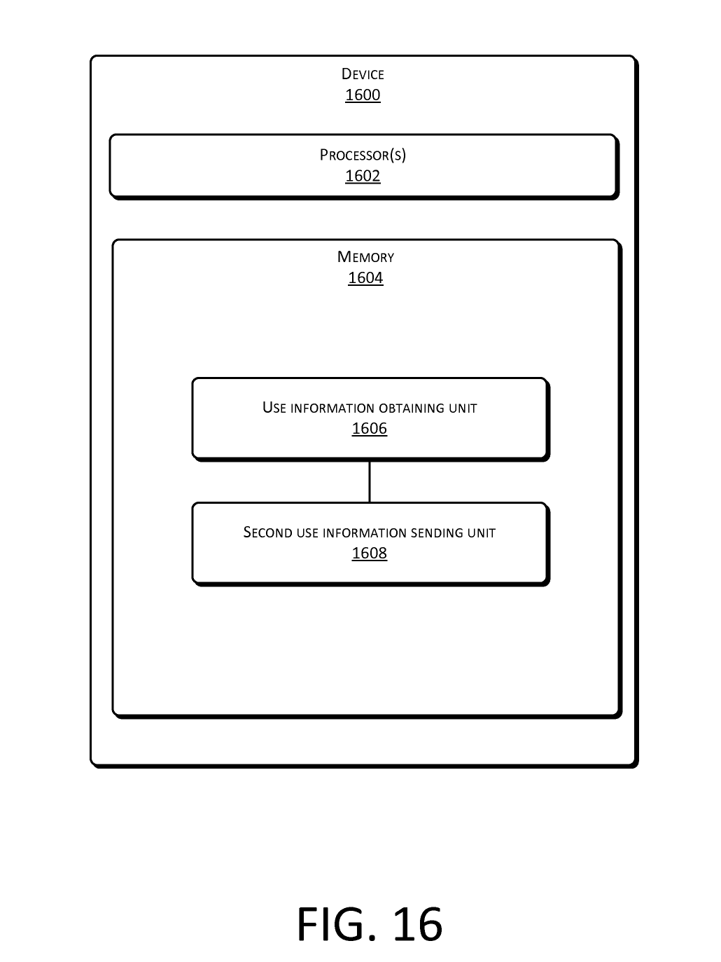

Corresponding to the example method of providing recommendation information of similar use information in the eighth example embodiment, the present disclosure also provides an example device of providing recommendation information of similar use information, as shown in FIG. 16. Such device may locate at the client. Referring to FIG. 16, an example device 1600 may include one or more processor(s) or data processing unit(s) 1602 and memory 1604. The memory 1604 is an example of computer-readable media. The memory 1604 may store therein a plurality of units including a use information obtaining unit 1606 and a second use information sending unit 1608.

The use information obtaining unit 1606 obtains use information of application programs used by a user at a terminal. The use information sending unit 1608 sends the use information of the application programs to a server so that the server determines information of a use sequence of application programs used by each terminal user according to the user information sent by each terminal, integrates the information of the use sequence of the application programs of each terminal, determines at least one second user that is similar to a first terminal user, and sends recommendation information of a similar terminal user.

The present techniques utilize a use sequence of application programs when the user users the application program to determine application programs that probably have the correlation relationship, and further provide the user recommendation information related to the application programs, thereby improving an effectiveness of the recommendation information, an efficiency of recommending resources, and user experiences.

In addition, the present techniques, after collecting the use sequence of the application programs used by the user, not only recommend application programs to the user that may be interested to him/her, but also provide recommend information of other users so that the user may find another that has similarity in using the application programs. Thus, the present techniques enable the user to conveniently find another user that has similar using habit.

One of ordinary skill in the art would clearly understand that the embodiments including the example clients or servers as described herein of the present disclosure may be achieved by hardware, software, or software that runs on necessary general hardware platforms. Based on such understandings, the technical solution or, the contribution to the prior art, of the present disclosure may be represented in the form of a software product which can be stored in computer storage media such as ROM/RAM, disk drive, optical disk, etc. The software product may include computer-executable instruction stored on the computer storage media that are executable by a computing device (such as a personal computer (PC), a server, or a network device) that implements each embodiment of the present disclosure or methods described in some portions of the embodiments.

Each example embodiment of the present disclosure is described in a progressive manner. Each embodiment details its difference from the other embodiments and the same or similar portions of the embodiments may be referenced to each other. For example, with respect to a system or an example system embodiment, as it is basically similar to the method embodiments, its descriptions may be simpler as the related content may be referred to the descriptions in the corresponding method embodiments. The above described systems or example system embodiments are merely illustrative. The unit that is described as a separate component may or may not be physically separate. A component that is illustrated as the unit may or may not be a physical unit, i.e., it may be positioned in a specific location or distributed to a plurality of network units. A part of or the entire modules or units may be selected according to the actual requirement to achieve the objective of the technical solutions according to the embodiments of the present disclosure. One of ordinary skill in the art would be able to understand and implement the present disclosure without creative effort.

The above description describes the example methods and devices of providing application program and user recommendation information of the present disclosure. The present disclosure uses specific example embodiments to illustrate principles and implementations of the present disclosure. The illustration of the example embodiments are only used for understanding the methods and the concepts of the present disclosure. One of ordinary skill in the art may make any revisions or variations to the specific embodiments and application scopes. Any change, equivalent replacement, or improvement without departing the spirit and scope of the present techniques shall still fall under the scope of the claims of the present disclosure. Accordingly, the description herein shall not be used to limit the present disclosure

What is claimed is:

1. A method comprising:
determining, by a terminal, information of a use sequence of application programs used by a user at the terminal; and
determining, by the terminal, a correlation relationship of the application programs according to the information of the use sequence.

2. The method of claim 1, further comprising uploading the correlation relationship of the application programs to a server.

3. The method of claim 2, further comprising:
integrating, by the server, the correlation relationship uploaded by each terminal to determine at least another application program that is correlated with a first application program; and
providing, by the server, recommendation information of the at least another application program.

4. The method of claim 3, further comprising:
receiving, by the terminal, the recommendation information of the at least another application program;
determining, by the terminal, that the first application program is locally installed and the at least another program is not locally installed; and
providing, by the terminal, the recommendation information of the at least another application program to the user.

5. The method of claim 1, further comprising:
determining, by the terminal, a second application program that is correlated with a first application program; and
adding entry information of the second application program at an operation interface of the first application program.

6. The method of claim 1, wherein:
the determining the information of the use sequence of application programs used by the user at the terminal comprises calculating a respective use sequence of application programs used by a respective user according to log-in information of the respective user; and
the determining the correlation relationship of the application programs according to the information of the use sequence comprises determining the correlation relationship of the application programs according to use sequences of different users.

7. The method of claim 1, wherein the determining the correlation relationship of the application programs according to the information of the use sequence comprises:
determining adjacent application programs as having a switching relationship according to the use sequence;
calculating a number of times that an application program is switched to another application program; and
determining that the application program and the another application program have the correlation relationship in response to determining that the number of times that the application program is switched to the another application program exceeds a predetermined threshold.

8. The method of claim 7, further comprising:
prior to the calculating the number of times that the application program is switched to the another application program, determining whether a time interval of a switching from the application program to the another application program does not exceed a predetermined time threshold; and
counting the switching in response to determining that the time interval of the switching does not exceed the predetermined time threshold.

9. The method of claim 1, wherein the determining information of the use sequence of the application programs used by the user at the terminal comprises:
recording time information of a respective application program that has been used; and
determining the use sequence of the application programs according to the time information of each respective application program.

10. The method of claim 1, further comprising:
uploading the correlation relationship of the application programs to a server;
integrating, by the server, the correlation relationship uploaded by each terminal to determine another user that is similar to the user; and
providing, by the server, recommendation information of the another user.

11. A method comprising:
determining, by a server, one or more correlation relationships of application programs from one or more terminals,
integrating the one or more correlation relationships to determine at least another application program that is correlated with a first application program; and
providing recommending information of the at least another application program to a terminal.

12. The method of claim 11, wherein the determining the one or more correlation relationships of the application programs from the one or more terminals comprises receiving a respective correlation relationship of the application programs from a respective terminal, the respective correlation relationship being determined by the respective terminal according to a respective use sequence of the application programs used by a respective user at the respective terminal.

13. The method of claim 11, wherein the providing the recommending information of the at least one third application program to the terminal comprises:
determining whether the terminal that installs the first application program also installs the at least another application program; and
providing the recommending information of the at least another application program to the terminal if the third application program is not installed at the terminal.

14. The method of claim 11, further comprising:
determining at least one second user that is similar to a first user by comparing similarities of the one or more correlation relationships sent by multiple terminals; and
providing recommending information of the at least one second user to the first user.

15. A method comprising:
receiving respective use information of application programs of a respective user from a respective terminal;
integrating use sequences from one or more respective terminals to determine at least another application program that is correlated with a first application program; and
providing recommending information of the at least another application program to a terminal.

16. The method of claim 15, further comprising determining a respective use sequence of the application programs used by the respective user according to the respective use information;

17. The method of claim 16, wherein the receiving respective use information of the application programs of the respective user from the respective terminal comprises receiving respective time information of a respective application program used at the respective terminal.

18. The method of claim 15, wherein the integrating comprises:
integrating the respective use information of the application programs from multiple terminals to determine a use sequence of the application programs;
determining adjacent application programs in the use sequence as having a switching relationship according to the use sequence;
calculating a number of times that a first application program is switched to another application program; and
determining that the first application program and the another application program have the correlation relationship in response to determining that the number of times that the first application program is switched to the another application program exceeds a predetermined threshold.

19. The method of claim 15, further comprising:
determining a similarity between a use sequence of a user and another use sequence of another user; and
providing recommending information related to the another user to the user in response to determining that the similarity exceeds a predetermined threshold.

20. The method of claim 19, wherein the determining the similarity comprises:
calculating a number of times switching from an application program to another application program of the user and the another user respectively according to the use sequence of the user and the another use sequence of the another user; and
determining the similarity between the use sequences of the user and the use sequences of the another user according to a result of the calculating of the number of times switching from the application program to the another application program of the user and the another user respectively.
